(19) United States
(12) Patent Application Publication
(10) Pub. No.: US 2019/0196000 A1
(43) Pub. Date: Jun. 27, 2019

(54) PROCESSING METHOD FOR MULTI-TARGET DETECTION, CHARACTERISATION AND TRACKING AND RELATED DEVICE

(71) Applicant: AVANTIX, Aix en Provence Cedex 3 (FR)

(72) Inventors: Hugo BOURGOIN, Aix en Provence (FR); Thomas COURTAT, Paris (FR)

(21) Appl. No.: 16/229,738

(22) Filed: Dec. 21, 2018

(30) Foreign Application Priority Data
Dec. 27, 2017 (FR) 1701382

(51) Int. Cl. G01S 13/72

(52) U.S. Cl. CPC G01S 13/726

(57) ABSTRACT

A method for processing measurements obtained by an antenna system at a given time index t, includes within a first list of clusters, a cluster including temporal characteristics, spatial characteristics and signal characteristics, predicting, at the time index t, the spatial characteristics of each cluster contained in the first list of clusters as a function of the spatial characteristics of the cluster when lastly updated to form a second list of clusters; for each measurement: forming a third list of clusters included in the second list, each cluster including the previously predicted spatial characteristics and calculating a likelihood score between the measurement and each cluster of the third list of clusters, the likelihood score being calculated from two factors; selecting the maximum likelihood score; and comparing the maximum likelihood score with a predetermined threshold.

### CROSS-REFERENCE TO RELATED APPLICATIONS

This application claims priority to French Patent Application No. 1701382, filed Dec. 27, 2017, the entire contents of which is incorporated herein by reference in its entirety.

### FIELD

The technical field of the invention is that of multi-target detection, characterisation and tracking.

The present invention particularly relates to a method for processing measurements. The present invention also relates to a device for implementing such a method.

### BACKGROUND

Conventional multi-target detection, characterisation and tracking algorithms require data provided by the user to be functional. For example, a conventional multi-target tracking algorithm has to know the number of targets to be tracked.

Thus, there is a need for detecting, characterising and tracking several targets at the same time without a user needing to provide a priori information on the targets to be tracked.

### SUMMARY

An aspect of the invention offers a solution to the previously discussed problems, by enabling several targets to be detected, characterised and tracked in an environment from measurements of this environment without a user providing initialisation data or updating data.

A first aspect of the invention relates to a method for processing measurements obtained by an antenna system at a given time index t, including the different following steps of:
within a first list of clusters, a cluster defined as a set of measurements including temporal characteristics, spatial characteristics and signal characteristics, a cluster being created from a first measurement and evolving as new measurements are produced, predicting, at the time index t, the spatial characteristics of each cluster contained in the first list of clusters as a function of the spatial characteristics of the cluster when lastly updated to form a second list of clusters;
for each measurement:
   forming a third list of clusters included in the second list, each cluster including the previously predicted spatial characteristics;
   calculating a likelihood score between the measurement and each cluster of the third list of clusters, the likelihood score being calculated from two factors, a first factor being a distance between the measurement and at least one spatial characteristic of the cluster and the second factor being the result of a statistical processing of the characteristics of the cluster;
   selecting the maximum likelihood score;
   comparing the maximum likelihood score with a predetermined threshold:
      if the maximum likelihood score is above the threshold, updating the characteristics of each cluster of the third list of clusters to form a fourth list of clusters integrating the information of the measurement;
      otherwise, creating a new cluster from the measurement and placing the new cluster in the second list of clusters.

By virtue of the invention, the clusters enable the gathering of measurements taken over time to be ensured and thus the tracking of the targets that have generated these measurements to be made. Indeed, a cluster is a set of measurements, created from a first measurement and which evolve as new measurements are produced. Therefore, the method enables the tracking of a plurality of targets to be ensured, each target corresponding to a cluster at a given time instant, without requiring information beforehand.

By measurements obtained by an antenna system at a given time index t, it is meant measurements obtained at a date Dₜ (designated indifferently by time instant t in the following of the description), the previously obtained measurements (i.e. at the time index t−1) being obtained at a date Dₜ₋₁. It will be noted that the deviations separating two consecutive dates ΔDt=Dₜ−Dₜ₋₁ are not necessarily always the same.

Besides the characteristics just discussed in the previous paragraph, the method according to an aspect of the invention can have one or more complementary characteristics from the following ones, considered singly or according to any technically possible combinations.

Beneficially, each measurement has temporal characteristics, spatial characteristics and signal characteristics which can be chosen from at least the group formed by the following characteristics:
for the temporal characteristics: a date;
for the spatial characteristics: a position, a position uncertainty, and possibly a direction of arrival and an uncertainty angle associated with the direction of arrival;
for the signal characteristics: a centre frequency, a bandwidth, a power, a signal to noise ratio, a modulation type, a polarisation, a transmission duration and three transmission mode probabilities corresponding to three transmission modes, burst, continuous and frequency hopped.

Beneficially, the characteristics of a cluster can be chosen from at least the group formed by the following characteristics:
for the temporal characteristics: a date of first detection, a date of last updating and a number of measurements;
for the spatial characteristics: a position, a position uncertainty and possibly a direction of arrival;
for the signal characteristics: a centre frequency, a bandwidth, a power, a signal to noise ratio, a transmission duration, a modulation type, a polarisation and three transmission mode probabilities corresponding to three transmission modes, burst, continuous and frequency hopped.

Beneficially, the method according to a first aspect of the invention includes a step of forming the first list of clusters before the predicting step to only keep each cluster of a list of clusters whose position is in a close geographical zone defined from the positions of the measurements or from the knowledge of the current position of the antennas of the antenna system.

Thus, only the clusters whose position is close to the position of the measurements are preserved which enables the calculation time to be decreased by only processing the clusters the most spatially close to the measurements.

Beneficially, the step of predicting the spatial characteristics of each cluster of the first list of clusters at the time index t is made in accordance with a Kalman prediction scheme from the temporal and spatial information of the cluster.

Thus, the prediction of the spatial characteristics at a time instant t depends on the prediction of the spatial characteristics at the time instant t−1 which enables the cluster to evolve as a function of its previous state.

Beneficially, the step of forming the third list of clusters includes a first filtering step to only keep each cluster of the second list of clusters meeting signal filtering conditions based on the signal characteristics of the measurement and the signal characteristics of the cluster.

Thus, only the clusters whose signal characteristics are close to the signal characteristics of the measurement are preserved which enables the calculation time to be decreased by only processing the most similar clusters to the measurement from the signal point of view.

Beneficially, the step of forming the third list of clusters includes a second filtering step to only keep each cluster of the second list of clusters meeting signal filtering conditions based on the signal characteristics of the measurement and the signal characteristics of the cluster.

Thus, only the clusters whose spatial characteristics are close to the spatial characteristics of the measurement are preserved which enables the calculation time to be decreased by only processing the most similar clusters to the measurement from the spatial point of view.

Beneficially, during the updating step, the signal characteristics and the spatial characteristics of each cluster of the third list of clusters are updated from the normalised likelihood score of the cluster associated with the measurement and with the cluster.

Thus, the measurement evolves each cluster as a function of the likelihood score associated with the cluster, that is the higher the likelihood score, the more the measurement has influence on the variation of the characteristics of the cluster.

Another aspect of the invention relates to a device enabling the method according to a first aspect of the invention to be implemented, including a calculation unit configured to make the steps of the method.

The invention and its different applications will be better understood upon reading the description that follows and upon examining the accompanying figures.

### BRIEF DESCRIPTION OF THE FIGURES

The figures are shown by way of indicating and in no way limiting purposes of the invention.

FIG. 1 shows a schematic representation of the method according to a first aspect of the invention according to a first embodiment.

FIG. 2 shows a schematic representation of a cluster.

FIG. 3 shows a schematic representation of a measurement.

FIG. 4 shows the step of updating the spatial characteristics of the clusters.

### DETAILED DESCRIPTION

Unless otherwise indicated, a same element appearing on different figures has a single reference.

A first aspect of the invention relates to a method 100 for processing measurements 1021 obtained from acquisitions made by an antenna system in an environment in which targets are desired to be detected, characterised and tracked. In the following of the present application, by target, it will be meant a transmitter a number of characteristics, as for example the position, the speed or even the transmission frequency, of which are desired to be known. The targets may be movable, that is the targets have a non-null speed but they can remain stationary for some time interval. By antenna system, it is meant a device including an antenna element capable of sensing measurements of its environment and to infer positions. The antenna system is in an embodiment airborne and movable.

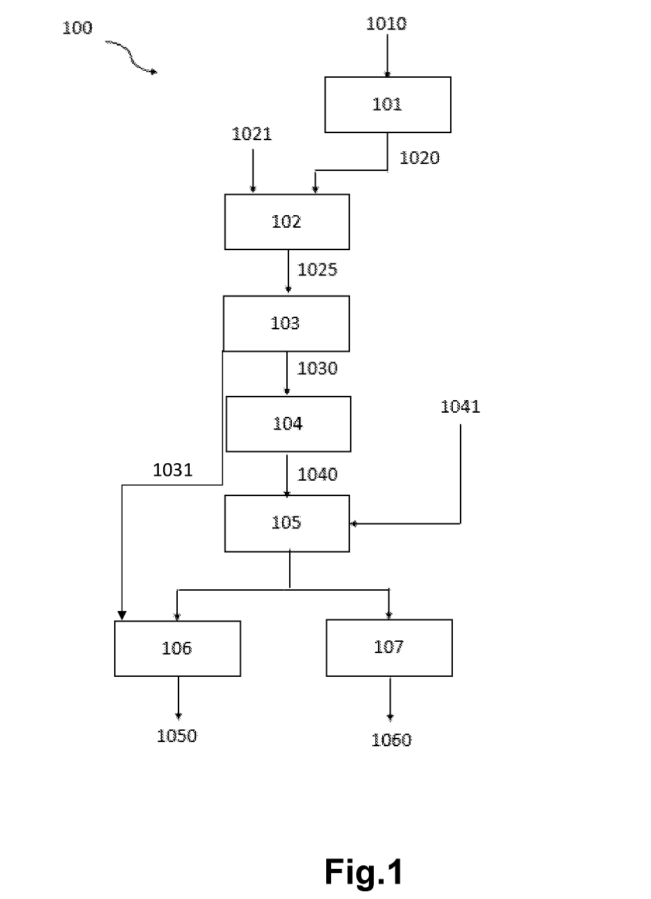

The method 100 according to a first aspect of the invention includes several steps the sequence of which is represented in FIG. 1. These steps are implemented by the device according to a second aspect of the invention including a calculation unit configured to make the steps 101 to 107 of the method 100.

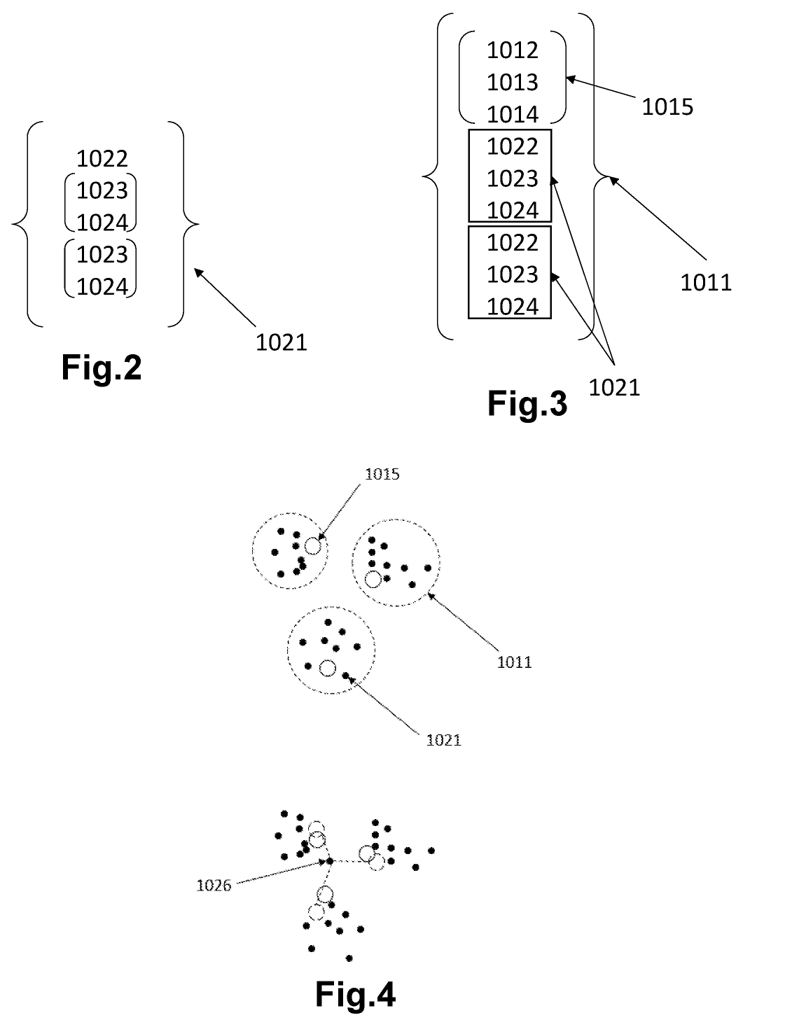

At a time instant t, a set of measurements is produced. By set of measurements 1021, it is meant a list dated by a temporal characteristic 1022 of measurements including spatial characteristics 1023 and signal characteristics 1024. The date of the set of measurements is viewed as a further so-called temporal characteristic 1022. For example, the set of measurements 1021 of FIG. 2 includes a temporal characteristic 1022 representing two measurements (or more generally a plurality of measurements) including spatial 1023 and signal 1024 characteristics. In an embodiment, the temporal characteristics 1022 are measurement dates. In an embodiment, the spatial characteristics 1023 are for example a position, a position uncertainty, a direction of arrival and an uncertainty angle associated with the direction of arrival. In an embodiment, the signal characteristics 1024 are for example a centre frequency, a bandwidth, a power, a signal to noise ratio, a transmission duration, a modulation type, a polarisation and three transmission mode probabilities corresponding to three transmission modes: burst, continuous and frequency hopped. By burst transmission mode, it is meant the transmission of a signal with a null power except on some short time intervals scattered over time. By continuous transmission mode, it is meant the transmission of a continuous signal. By frequency hopped transmission mode, it is meant the transmission of a signal which alternately uses several sub-channels distributed in a frequency band according to a given sequence, for example a pseudo-random sequence.

A list of clusters generated at the time instant t−1 is available. The list of clusters can be empty or include one or more clusters 1011. By cluster 1011, it is meant a set of characteristics 1015 that can be of three types: temporal characteristics 1012, spatial characteristics 1013 and signal characteristics 1014 as illustrated in FIG. 3. For example, the cluster 1011 of FIG. 3 includes temporal characteristics 1012, spatial characteristics 1013 and signal characteristics 1014 and gathers the history of a plurality of measurements 1021 (here two measurements 1021) from which its characteristics 1015 are updated. In an embodiment, the temporal characteristics 1022 are for example a creation date, a last update date and a number of measurements. In an embodiment, the spatial characteristics 1023 are for example a position, a position uncertainty and possibly a direction of arrival. In an embodiment, the signal characteristics 1024 are for example a centre frequency, a bandwidth, a power, a signal to noise ratio, a transmission duration, a modulation type, a polarisation and three transmission mode probabilities corresponding to three transmission modes: burst, continuous and frequency hopped. As discussed above, a cluster 1011 is also a gathering of measurements 1021 as illustrated in FIG. 4 in which each cluster 1011 encompasses a plurality of measurements 1021 from which its characteristics 1015 are updated. In FIG. 4, the updating of the position 1015 of three clusters 1011 is illustrated by adding a new measurement 1026.

According to a first embodiment, the list of clusters generated at the time instant t−1 is a first list of clusters 1010.

According to a second embodiment, the first list of clusters 1010 is a sub-list of the list of clusters generated at the time instant t−1. A filtering is made to remove each cluster 1011 whose position 1015 is not in a geographical zone close to the positions of the measurements 1021. It is possible for example to calculate the barycentre of the positions of the measurements 1021. The geographical zone is thereby for example a circle having as a centre the barycentre and having a diameter for example between 200 and 300 km. The first list of clusters 1010 is thereby formed by the clusters 1011 of the list of clusters generated at the time instant t−1 that have not been removed by filtering.

It is also possible to couple the previous filtering with a temporal filtering which removes each cluster 1011 from the list of clusters generated at the time instant t−1 the date of last update of which is too far from the current date, which means that the target which has generated the measurements 1021 gathered in the cluster 1011 was from a mistake or has been switched OFF since then.

Once the first list of clusters 1010 is obtained, the step 101 of predicting the spatial characteristics 1013 of each cluster 1011 of the first list of clusters 1010 is made. Indeed, the first list of clusters 1010 includes clusters 1011 the spatial characteristics 1013 of which have been evaluated at the time instant t−1, that is, for example, the position 1015 of each cluster 1011 is that obtained at the time instant t−1. Since the targets to be tracked are movable, the spatial characteristics 1013 of the clusters 1011 vary over time. This prediction step 101 enables the spatial characteristics 1013 of a cluster 1011 of the first list of clusters 1010 to be predicted, as for example its position 1015, at the time instant t from the spatial characteristics 1013 of the same cluster 1011 at time instant t−1. In an embodiment, this prediction step 101 is made according to a Kalman prediction integrating the position estimated at t−1, the uncertainties related to this estimation and the difference between the dates t and t−1. The updated clusters 1011 of the first list of clusters 1010 form a second list of clusters 1020.

The following steps 102 to 107 are made for each measurement 1021 obtained at time instant t.

According to a first embodiment, a third list of clusters 1025 is formed from the clusters 1011 of the second list of clusters 1020 the spatial characteristics 1013 of which have been predicted in the previous step 101.

According to a second embodiment, the step 102 of forming the third list of clusters 1025 includes a first filtering step during which the clusters 1011 of the second list of clusters 1020 meeting signal filtering conditions are added to the third list of clusters 1025 which was initially empty.

The signal filtering conditions are based on the signal characteristics 1014 of each cluster 1011 of the second list of clusters 1020 and on the signal characteristics 1024 of the measurement 1021 being processed. For example, the signal filtering conditions for a cluster 1011 are chosen from at least the group formed by the following conditions:
a transmission mode for the cluster 1011 is identical to a transmission mode for the measurement 1021, the transmission mode for the cluster 1011 being the transmission mode the probability of which is the highest among the three transmission mode probabilities for the cluster 1011 and the transmission mode of the measurement 1021 being the transmission mode the probability of which is the highest among the three transmission mode probabilities for the measurement 1021. For example, if the highest probability among the three transmission mode probabilities of the cluster 1011 is the probability that the transmission mode is burst, the transmission mode is considered as burst for the cluster 1011 and if the highest probability among the three transmission mode probabilities of the measurement 1021 is the probability that the transmission mode is frequency hopped, the transmission mode is considered as frequency hopped, the transmission mode for the cluster 1011 is thereby not identical to the transmission mode of the measurement 1021;
the difference between the transmission duration of the measurement 1021 and the transmission duration of the cluster 1011 is lower than a multiple of a temporal resolution associated with the acquisition of the measurement 1021;
if the transmission mode of the measurement 1021 is frequency hopped, the frequency of the measurement 1021 and the frequency of the cluster 1011 are included in a same frequency band;
the difference between the frequency of the measurement 1021 and the frequency of the cluster 1011 is lower than a multiple of a frequency resolution associated with the acquisition of the measurement 1021.

At the end of the step 102 of forming the third list of clusters 1025, only the clusters 1011 of the second list of clusters 1020 meeting the chosen signal filtering conditions are placed in the third list of clusters 1025.

According to a third embodiment, the clusters 1011 selected at the end of the first filtering step are not directly placed in the third list of clusters 1025 but in an initially empty intermediate list of clusters.

The step 102 of forming the third list of clusters 1025 thereby includes a second filtering step during which the clusters 1011 of the intermediate list of clusters meeting a spatial filtering condition are added to the third list of clusters 1025 which was initially empty. The spatial filtering condition is based on the spatial characteristics 1013 of each cluster 1011 of the intermediate list of clusters and on the spatial characteristics 1023 of the measurement 1021 being processed. In an embodiment, the spatial filtering condition is that the angle between the direction of arrival of the measurement 1021 and the direction of arrival of the cluster 1011 has a value lower than 3/2 times the uncertainty angle associated with the direction of arrival of the measurement 1021 being processed.

At the end of the step 102 of forming the third list of clusters 1025, only the clusters 1011 of the intermediate list of clusters meeting the chosen spatial filtering condition are placed in the third list of clusters 1025.

According to a fourth embodiment, step 102 of forming the third list of clusters 1025 only includes the second filtering step which forms the third list of clusters 1025 from the clusters 1011 of the second list of clusters 1020 meeting the spatial filtering condition.

Once the third list of clusters 1025 associated with the measurement 1021 being processed is formed, the step 103 of calculating the likelihood score is made. A likelihood score 1030 is calculated between the measurement 1021 and each cluster 1011 of the third list of clusters 1025. The number of likelihood scores 1030 calculated is thus equal to the cardinal of the third list of clusters 1025. By cardinal of a list, it is meant the number of elements of the list.

The likelihood score 1030 between the measurement 1021 and a cluster 1011 of the third list of clusters 1025 is calculated from two factors.

A first factor defines a distance between the measurement 1021 and the cluster 1011. In an embodiment, this distance is based on the signal characteristics 1024 of the measurement 1021 and the signal characteristics 1014 of the cluster 1011. In an embodiment, the distance is calculated from three sub-factors, each sub-factor being related to a single signal characteristic 1024 of the measurement 1021. The distance is thereby expressed as:

d(m,cᵢ)=sf₁×sf₂×sf₃

with d(m,cᵢ) the distance between the measurement m and the i^{th} cluster 1011 of the third list of clusters 1025, sf₁ a first sub-factor, sf₂ a second sub-factor and sf₃ a third sub-factor.

The first sub-factor depends for example on the frequency: if the cluster 1011 has a frequency hopped transmission mode, it is for example 1 and if the cluster 1011 has a continuous transmission mode, it is:

$${sf}_{1} = 1 - \frac{Δ f}{Δ {f}_{max}}$$

with Δfₘₐₓ a function of the acquisition parameters of the measurement 1021 and with:

Δf=|fₘ−f_{ci}|

with fₘ the frequency of the measurement m 1021 and f_{ci} the frequency of the i^{th} cluster 1011 of the third list of clusters 1025.

The second sub-factor depends for example on the bandwidth: it is for example the bandwidth of the measurement 1021.

The third sub-factor depends for example on the transmission duration: it is for example:

sf₃=1−Δt

with:

$$Δ t = \frac{\vert {d}_{m} - {d}_{ci} \vert}{{d}_{ci}}$$

with dₘ the transmission duration of the measurement m 1021 and d_{ci} the transmission duration of the i^{th} cluster 1011 of the third list of clusters 1025.

Finally, the first factor F₁ is expressed as:

$${F}_{1} ( m , {c}_{i} ) = \frac{1}{d ( m , {c}_{i} )} .$$

The second factor is the result of a statistical processing on the characteristics of the cluster 1011. In an embodiment, the second factor F₂ is expressed as:

$${F}_{2} ( m , {c}_{i} ) = \frac{\frac{exp ( - s ( m , {c}_{i} ) )}{n ( m , {c}_{i} )}}{{Σ}_{k} \frac{exp ( - s ( m , {c}_{k} ) )}{n ( m , {c}_{k} )}}$$

with the sum of all the clusters 1011 of the third list of clusters 1025 and:

$$s ( m , {c}_{i} ) = \frac{exp ( - dist ( m , {c}_{i} ) )}{n ( m , {c}_{i} )}$$

with dist(m,cᵢ) defining a distance between the position of the measurement m 1021 and the position predicted in the step 101 of predicting the i^{th} cluster 1011 and n(m,cᵢ) enabling the position uncertainties to be taken into account.

The likelihood score S 1030 is expressed as:

s(m,cᵢ)=F₁(m,cᵢ)×F₂(m,cᵢ)

And finally, the normalised likelihood score SN (step 1031) is expressed as:

$$SN ( m , {c}_{i} ) = \frac{S ( m , {c}_{i} )}{{Σ}_{j} S ( m , {c}_{j} )}$$

Once each likelihood score 1030 associated with a cluster 1011 of the third list of clusters 1025 has been calculated, the selection step 104 consists in selecting the maximum likelihood score 1040 from all the likelihood scores 1030.

Once the maximum likelihood score 1040 is selected, the comparison step 105 consists in comparing the maximum likelihood score 1040 with a predetermined threshold 1041. If the maximum likelihood score 1040 is below or equal to the threshold 1041, the step 106 of updating the characteristics 1015 of each cluster 1011 of the third list of clusters 1025 is made. Otherwise, the step 107 of creating of a new cluster 1060 is made.

The step 106 of updating the characteristics 1015 of each cluster 1011 of the third list of clusters 1025 consists in updating the spatial characteristics 1013 and the signal characteristics 1014 of each cluster 1011 from its likelihood score 1030, updating the date of last update of the cluster 1011 with the current date and incrementing the number of measurements of the cluster 1011 by 1.

In an embodiment, the updating of the spatial characteristics 1013 of each cluster 1011 of the third list of clusters 1025 is made according to a Kalman correction scheme the gain of which is multiplied by the normalised likelihood score 1031 associated with the cluster 1011 which is being updated. This updating of the spatial characteristics 1014 is illustrated in FIG. 4. In FIG. 4, three clusters 1011 are represented: each cluster 1011 gathers a plurality of measurements 1021 and has a position 1015. Adding a new measurement 1026 causes the position 1015 of each cluster 1011 to be updated.

In an embodiment, all the signal characteristics 1014 of a cluster 1011 are updated from its normalised likelihood score 1031. For example, the frequency of the updated cluster 1011 is expressed as:

f_{ci}(t)=f_{ci}(t−1)+SN(m,cᵢ)×fₘ

with f_{ci}(t) the updated frequency of the i^{th} cluster 1011 of the third list of clusters 1025, f_{ci}(t−1) the frequency before updating the i^{th} cluster 1011 of the third list of clusters 1025, SN(m,cᵢ), the normalised likelihood score 1031 associated with the measurement m 1021 and with the i^{th} cluster 1011, fₘ the frequency of the measurement m 1021 and N the number of measurements of the i^{th} cluster 1011.

The clusters 1011 of the third list of updated clusters 1025 are added to a fourth list of clusters 1050 which was initially empty.

The step 107 of creating a new cluster 1060 consisting giving as values to the spatial characteristics 1013 and to the signal characteristics 1014 of the new cluster 1060 the values of the spatial characteristics 1023 and the signal characteristics 1024 of the measurement 1021 respectively. For example, the position 1015 of the new cluster 1060 takes the value of the position of the measurement 1021. The number of measurements of the cluster 1011 takes the value 1 and the date of last update is initialised to 0. The other temporal characteristics 1012 of the new cluster 1060 take the values of the temporal characteristics of the measurement 1021. The new cluster 1060 is then placed in the second list of clusters 1020.

After all the steps of the method 100 have been made for all the measurements 1021 obtained at the time instant t, each cluster 1011 gives information on a target as for example its position, its speed or even its transmission characteristics. For example, at each time instant, the position of each cluster 1011 gives the position of each target of the environment.

Having described and illustrated the principles of the invention with reference to various embodiments, it will be recognized that the various embodiments can be modified in arrangement and detail without departing from such principles. It will be appreciated that the different concepts and aspects of the invention described above can be implemented, for example, using one or more processors, modules, machine executable instructions, computers and/or servers. It should be understood that the concepts and aspects of the invention described herein are not related or limited to any particular type of computing environment, unless indicated otherwise. Various types of specialized computing environments may be used with or perform operations in accordance with the teachings described herein. Elements of embodiments shown in software may be implemented in hardware and vice versa.

One or more devices, processors or processing devices may be configured to carry out the function(s) of each of the elements and modules of the structural arrangement described herein. For example, the one or more devices, processors or processing devices may be configured to execute one or more sequences of one or more machine executable instructions contained in a main memory to implement the method(s) or function(s) described herein. Execution of the sequences of instructions contained in a main memory causes the processors to perform at least some of the process steps or function(s) of the elements described herein. One or more processors in a multi-processing arrangement may also be employed to execute the sequences of instructions contained in a main memory or computer-readable medium. In alternative embodiments, hard-wired circuitry may be used in place of or in combination with software instructions. Thus, embodiments are not limited to any specific combination of hardware circuitry and software. The term “computer-readable medium” as used herein refers to any medium that participates in providing instructions to a processor for execution. Such a medium is non-transitory and may take many forms, including but not limited to, non-volatile media, volatile media, and transmission media. Non-volatile media include, for example, optical or magnetic disks. Volatile media include dynamic memory. Transmission media include coaxial cables, copper wire and fiber optics. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read. Various forms of computer readable media may be involved in carrying one or more sequences of one or more instructions to processor for execution.

Computer programs comprising machine executable instructions for implementing at least one of the steps of the methods, and/or aspects and/or concepts of the invention described herein or function(s) of various elements of the structural arrangement described herein can be implemented by one or more computers comprising at least an interface, a physical processor and a non-transitory memory (also broadly referred to as a non-transitory machine readable or storage medium). The computer is a special purpose computer as it is programmed to perform specific steps of the method(s) described above. The non-transitory memory is encoded or programmed with specific code instructions for carrying out the above method(s) and its/their associated steps. The non-transitory memory may be arranged in communication with the physical processor so that the physical processor, in use, reads and executes the specific code instructions embedded in the non-transitory memory. The interface of the special purpose computer may be arranged in communication with the physical processor and receives input parameters that are processed by the physical processor.

It will be appreciated by one skilled in the art that the disclosed arrangements and methods described herein represent a solution to the technological problem described above.

1. A method for processing measurements obtained by an antenna system at a given time index t, comprising:
within a first list of clusters, a cluster defined as a set of measurements including temporal characteristics, spatial characteristics and signal characteristics, a cluster being created from a first measurement and evolving as new measurements are produced, predicting, at the time index t, the spatial characteristics of each cluster contained in the first list of clusters as a function of the spatial characteristics of the cluster when lastly updated to form a second list of clusters;
for each measurement:
forming a third list of clusters included in the second list, each cluster including the previously predicted spatial characteristics;
calculating a likelihood score between the measurement and each cluster of the third list of clusters, the likelihood score being calculated from two factors, a first factor being a distance between the measurement and at least one spatial characteristic of the cluster and the second factor being the result of a statistical processing of the characteristics of the cluster;
selecting the maximum likelihood score;
comparing the maximum likelihood score with a predetermined threshold:
if the maximum likelihood score is above the threshold, updating the characteristics of each cluster of the third list of clusters to form a fourth list of clusters integrating the information of the measurement;
otherwise, creating a new cluster from the measurement and placing the new cluster in the second list of clusters.

2. The method according to claim 1, wherein each measurement has temporal characteristics, spatial characteristics and signal characteristics which can be chosen from at least the group formed by the following characteristics:
for the temporal characteristics: a date;
for the spatial characteristics: a position, a position uncertainty, and possibly a direction of arrival and an uncertainty angle associated with the direction of arrival;
for the signal characteristics: a centre frequency, a bandwidth, a power, a signal to noise ratio, a transmission duration, a modulation type, a polarisation and three transmission mode probabilities corresponding to three transmission modes, burst, continuous and frequency hopped.

3. The method according to claim 1, wherein the characteristics of a cluster can be chosen from at least the group formed by the following characteristics:
for the temporal characteristics: a date of first detection, a date of last updating and a number of measurements;
for the spatial characteristics: a position, a position uncertainty and possibly a direction of arrival;
for the signal characteristics: a centre frequency, a bandwidth, a power, a signal to noise ratio, a transmission duration, a modulation type, a polarisation and three transmission mode probabilities corresponding to three transmission modes, burst, continuous and frequency hopped.

4. The method according to claim 1, further comprising forming the first list of clusters before the predicting step to only keep each cluster of a list of clusters whose position is in a close geographical zone defined from the positions of the measurements or from the knowledge of the current position of the antennas of the antenna system.

5. The method according to claim 1, wherein predicting the spatial characteristics of each cluster of the first list of clusters at the time index t is made in accordance with a Kalman prediction scheme from the temporal and spatial information of the cluster.

6. The method according to claim 1, wherein forming the third list of clusters includes a first filtering step to only keep each cluster of the second list of clusters meeting signal filtering conditions based on the signal characteristics of the measurement and on the signal characteristics of the cluster.

7. The method according to claim 1, wherein forming the third list of clusters includes a second filtering step to only keep each cluster of the second list of clusters meeting a spatial filtering condition based on the spatial characteristics of the measurement and on the spatial characteristics of the cluster.

8. The method according to claim 1, wherein during the updating, the signal characteristics and the spatial characteristics of each cluster of the third list of clusters are updated from the normalised likelihood score of the cluster associated with the measurement and with the cluster.

9. A device comprising a calculation unit configured to perform the steps of the method according to claim 1.
